(19) United States
(12) Patent Application Publication
(10) Pub. No.: US 2015/0356474 A1
(43) Pub. Date: Dec. 10, 2015

(54) REAL-TIME CORRELATION OF DATA MODEL DATA

(71) Applicant: Rouven Day, Waghaeusel (DE)

(72) Inventor: Rouven Day, Waghaeusel (DE)

(21) Appl. No.: 14/300,891

(22) Filed: Jun. 10, 2014

(51) Int. Cl. G06Q 10/06

(52) U.S. Cl. CPC G06Q 10/0631; G06Q 10/067

(57) ABSTRACT

The present disclosure relates to a computer implemented method comprises obtaining, by operation of a hardware processor, a data model including structured data items for a business scenario, wherein executing an instance of the business scenario involves contributions of two or more computer systems, generating an instance of the business scenario, obtaining a modification of one or more data items of the data model relevant for a status of the business scenario, triggered by the modification of one or more data items of the data model, determining that the received modification is relevant for a status of the business scenario, triggered by the modification of the one or more data items of the data model, generating an event data item being indicative of a status of the business scenario and storing the event data item in a database object to be provided to a user using a user interface of a business scenario monitoring application.

### TECHNICAL FIELD

The present disclosure relates to methods and systems for database systems. In particular, the present disclosure relates to a method for real-time correlation of data model data in business scenarios.

### BACKGROUND

In some state-of-the-art database systems, it is possible to monitor a (potentially complex) business scenario using a single user interface of a business scenario management application. The business scenario can include contributions of different computer systems (e.g., computer systems of multiple internal or external business units involved in a particular business scenario, such as human resources, controlling, object management and many more). Efficiently and quickly integrating data from such a multitude of sources in a single monitoring application can be technically challenging.

### SUMMARY

In a first general aspect of the present disclosure a computer implemented method comprises obtaining, by operation of a hardware processor, a data model including structured data items for a business scenario, wherein executing an instance of the business scenario involves contributions of two or more computer systems, generating an instance of the business scenario, obtaining a modification of one or more data items of the data model relevant for a status of the business scenario, triggered by the modification of one or more data items of the data model, determining that the received modification is relevant for a status of the business scenario, triggered by the modification of the one or more data items of the data model, generating an event data item being indicative of a status of the business scenario and storing the event data item in a database object to be provided to a user using a user interface of a business scenario monitoring application.

In a second aspect according to the first aspect, the data model and the database object including the event data item are stored in an in-memory database.

In a third aspect according to the first or second aspect, the relevance for a status of the business scenario is determined by evaluating a condition having the modified one or more data items as input.

In a fourth aspect according to any one of the preceding aspects, the computer implemented method further includes obtaining a further modification of one or more second data items of the data model relevant for a status of the business scenario, triggered by the further modification of one or more second data items of the data model, determining that the received further modification is relevant for a status of the business scenario, triggered by the further modification of the one or more second data items of the data model, generating a second event data item being indicative of a status of the business scenario and storing the second event data item in a database object to be provided to a user using a user interface of a business scenario monitoring application.

In a fifth aspect according to any one of the preceding aspects, the obtained modification originates from the user interface of the business scenario monitoring application.

In a sixth aspect according to any one of the preceding aspects, the modification of one or more data items is a create operation, an update operation, or a delete operation, or a combination of two or more of these operations.

In a seventh aspect according to any one of the preceding aspects, the one or more data items of the data model are stored in one or more data tables referenced by the data model.

In an eighth aspect according to the seventh aspect, the one or more data tables each include a primary key and a scenario instance identifier identifying the corresponding scenario instance.

In a ninth aspect according to the eighth aspect, the event data item is indicative of a status of the business scenario is correlated to the scenario instance by using the scenario instance identifier.

In a tenth aspect according to the ninth aspect, storing the event data item in a database object includes storing information indicative of the corresponding scenario instance.

In an eleventh aspect according to any one of the seventh to tenth aspects, the code encoding the processes for determining that the received modification is relevant for a status of the business scenario is stored in an in-memory database object.

In a twelfth aspect according to any one of the preceding aspects, receiving a modification of one or more data items of the data model includes receiving an open data protocol (OData) service request.

In a thirteenth aspect according to any one of the preceding aspects, the computer implemented method further includes receiving a read request from the user interface of the business scenario monitoring application and providing status data based on the event data item to the user interface of the business scenario monitoring application for display to a user.

In a fourteenth aspect according to the thirteenth aspect, the read request is triggered by the modification of one or more data items of the data model.

In a fifteenth aspect according to any one of the preceding aspects, the business scenario includes one or more predetermined phases, and a status of the business scenario includes that a predetermined phase has been started or that a predetermined phase has been completed.

In a sixteenth aspect according to the fifteenth aspect, each phase of the one or more phases involves a contribution of a different one of the two or more computer systems.

In a seventeenth aspect according to any one of the preceding aspects, the computer implemented method further includes receiving data from at least one of the two or more computer systems and storing the received data in a database object.

In an eighteenth aspect according to the seventeenth aspect, determining that the received modification is relevant for a status of the business scenario includes evaluating data received from the least one of the two or more computer systems.

In a second general aspect of the present disclosure a computer readable medium stores instructions thereon which when executed by a processor cause the processor to carry out the operations of any one of the first to eighteenth aspects above.

In a third general aspect of the present disclosure a system includes a one or more processors and a computer-readable medium storing instructions executable by the one or more processors to perform operations comprising the operations of any one of the first to eighteenth aspects above.

### BRIEF DESCRIPTION OF THE DRAWINGS

FIG. 1 illustrates a layout of an example business scenario monitoring application according to an implementation.

FIG. 2 illustrates a data flow diagram of an example business scenario monitoring application according to an implementation.

FIG. 3A illustrates an example batch event processing in an example business scenario monitoring application according to an implementation.

FIG. 3B illustrates an example event-triggered event processing in an example business scenario monitoring application according to an implementation.

FIG. 4 illustrates an example method to generate correlated events in a business scenario monitoring application according to an implementation.

### DETAILED DESCRIPTION

The present disclosure relates to methods and systems for database systems. In particular, the present disclosure relates to a method for real-time correlation of data model data in business scenarios.

The subject-matter described in this disclosure can be implemented in particular embodiments so as to realize one or more of the following advantages:

First, a user can receive more timely feedback regarding the effect(s) of modification(s) of data related to a business scenario in a business scenario monitoring application. In some situations, a delay between a modification data related to the business scenario and a corresponding update of a status in the business scenario monitoring application can be short enough such that the update is perceived by a user as happening in real-time. As used in the present disclosure, “real-time” means without a delay that is recognized by the user (e.g., in less than two seconds). In this manner, a seamless user experience can be provided and the handling of the interface of the business scenario monitoring application can be more convenient.

Second, the techniques described herein can make maintaining the business scenario monitoring application more convenient. The implementation can be more light-weight and thus easier to maintain for a technician (as used in the present disclosure, a “technician” is a person who maintains, modifies or updates a business scenario monitoring application. In contrast to that, a “user” uses a business scenario monitoring application to monitor a business scenario. This might involve modifying data of the business scenario monitoring application. A single person can act as a technician and as a user at different times.)

As used in the present disclosure, a “business scenario” is a model of a particular course of (at least partially interdependent) real-world actions or real-world events to achieve a particular goal or a set of interrelated goals. It is not limited to business-related actions or events in a strict sense (e.g., selling or buying goods). For instance, a relocation of an employee of a company can be modeled as a relocation business scenario. Other examples can include a product launch business scenario, a training scenario for new employees, a database migration business scenario and so forth. These exemplary business scenarios are meant to be illustrative, not limiting. In some examples, a business scenario can have different phases that can happen in parallel or in series. In some examples, a completion of a first phase of a business scenario is a condition (e.g., sufficient or necessary) for a start of a second phase of the business scenario.

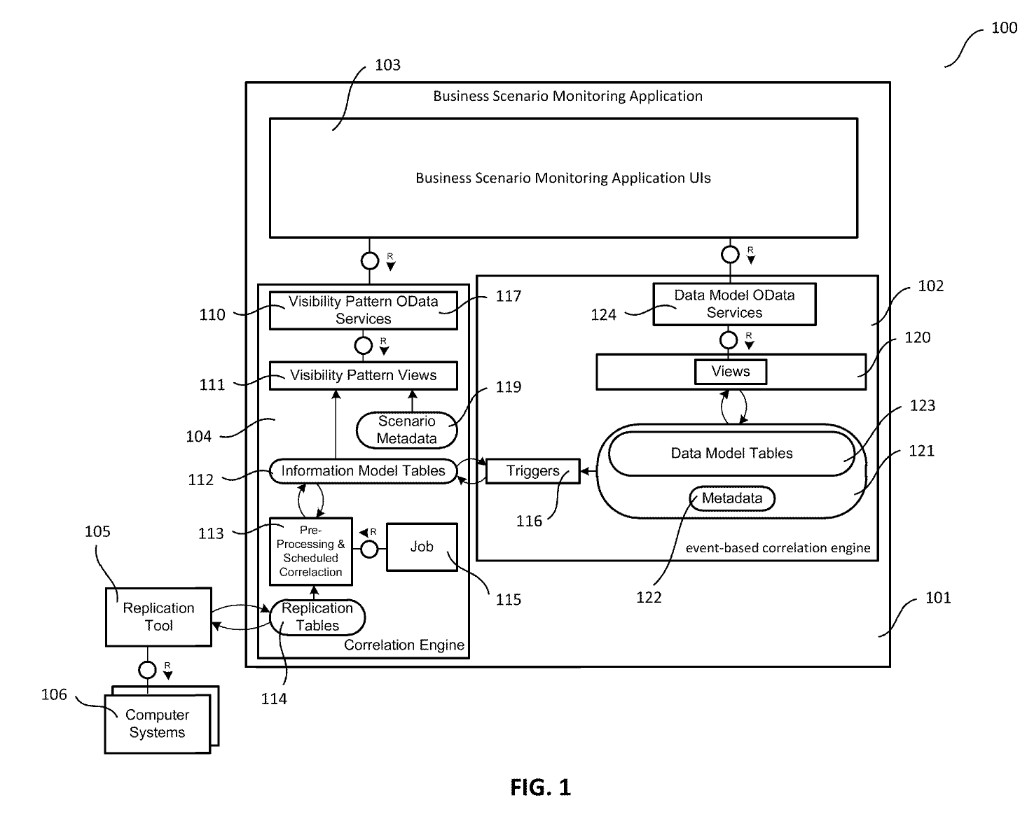

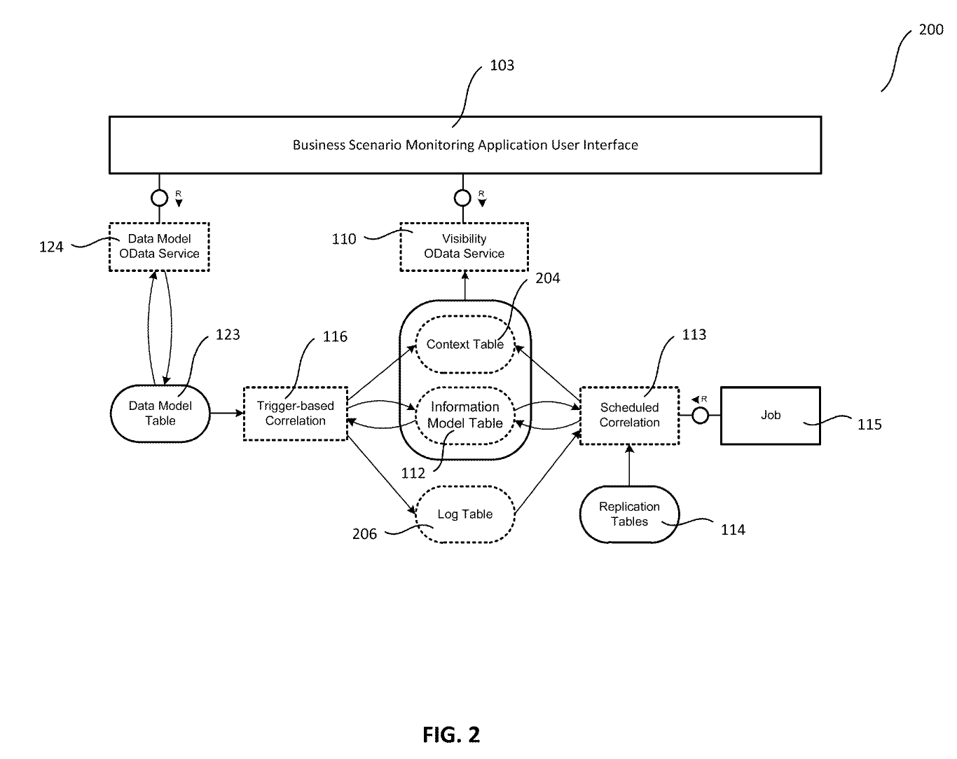

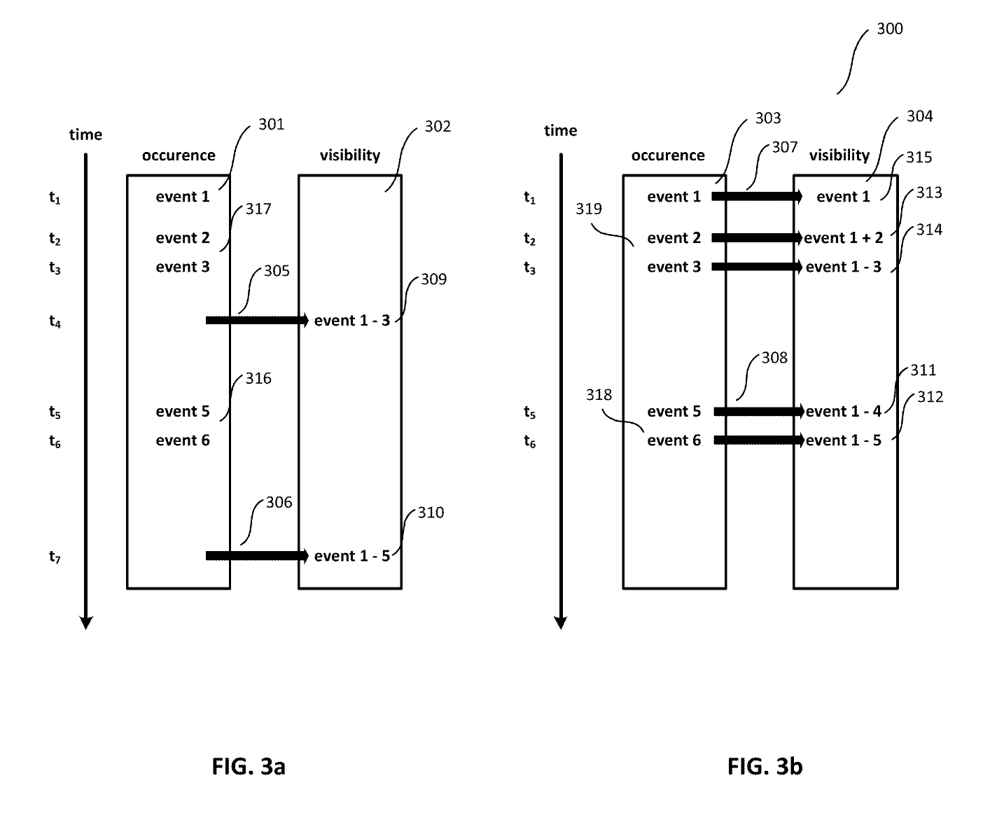

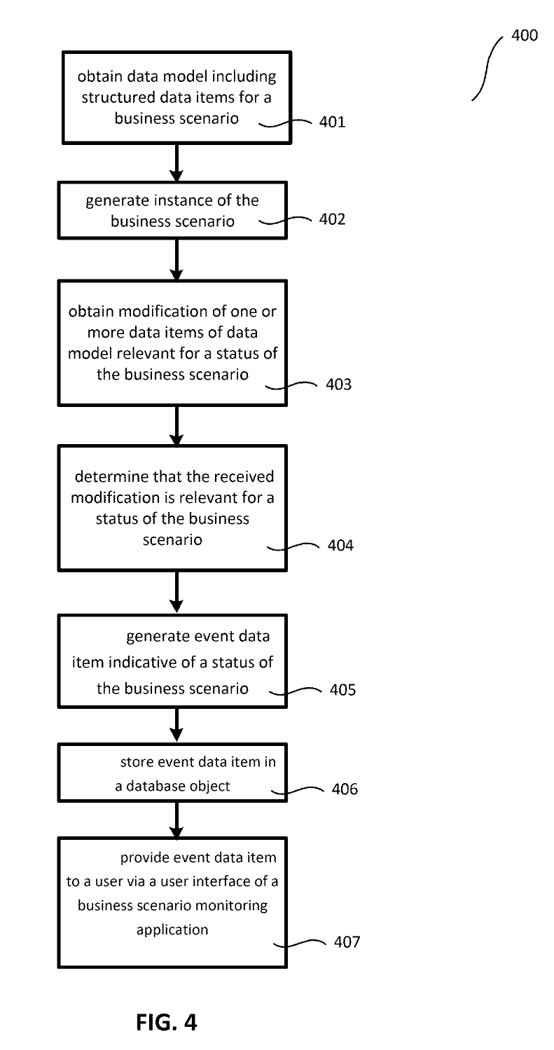

In a first part of the present disclosure, aspects of the layout of business scenario monitoring applications will be discussed in connection with FIG. 1. Subsequently, in connection with FIG. 2, details of a data model of a layout of an example business scenario monitoring application will be described. Aspects of the operation of a layout of an example business scenario monitoring application as described herein will be illustrated in connection with FIG. 3. Finally, in connection with FIG. 4, an example method in a business scenario monitoring application will be discussed.

FIG. 1 illustrates a layout of an example business scenario monitoring application according to an implementation. The business scenario monitoring application 101 can include multiple functional sub-units, which will be explained in more detail below. The business scenario monitoring application 101 interfaces with one or more computer systems 106. These computer systems 106 belong to different external and internal business units contributing to the real-world execution of the business scenario. For instance, in the relocation business scenario example introduced above, one of the computer systems 106 can be a computer system of a human resources business unit of a particular company. A second, separate computer system 106 can be a computer system of a real estate management division of the company managing houses and apartments of the company. A further computer system can be the computer system of an external real-estate broker or a law firm handling requesting a working permit of the employee to be relocated in a particular country. Again, these merely illustrative examples show that a variety of different computer systems can be interfaced with and monitored by the business scenario monitoring application 101. The computer systems 106 can be physically distributed over different locations and can have substantially different layouts. In addition, the computer systems 106 can run different database systems, or the same database system.

As shown in FIG. 1, a replication tool 105 is configured to fetch data from data items of the computer systems 106 and store it into replication tables 114 of the business scenario monitoring application 101. In this manner, the replicated data can be made available for further processing to the business scenario monitoring application 101. For example, in the course of a relocation business scenario, a user interacting with a user at a computer system 106 of a real-estate management business unit can add information regarding a suitable housing object at the new workplace of the employee to be relocated. Alternatively, a user at the human resource business unit's computer system 106 can check a suitable housing object and mark the “housing search phase” of the relocation business scenario as complete. The replication tool 105 can (at least partially) replicate this data in the replication tables 114 of a business scenario monitoring application 101 as this data can be of relevance for monitoring a progress of the relocation business scenario in the business scenario monitoring application 101.

In some business scenario monitoring applications 101, the data in the replication tables 114 are periodically processed by a preprocessing and scheduled correlation unit 113. This operation can be triggered by a scheduled job 115. The scheduled job 115 is launched at predetermined times which have to be specified through a configuration parameter at runtime of the business scenario monitoring applications 101. In the course of the correlation operation, the preprocessing and scheduled correlation unit 113 assigns a particular business scenario instance to the data in the replication tables 114 (e.g., a particular business scenario instance for whose status the data is relevant). For instance, there can be multiple business scenario instances of a particular (or different) business scenario type (e.g., multiple relocation business scenarios). The preprocessing and scheduled correlation unit 113 can assign the data in the replication tables 114 to one of these business scenario instances. In addition or alternatively, the preprocessing and scheduled correlation unit 113 can interpret data in the replication tables 114 to determine their relevance for a status for a particular business scenario instance. For instance, a phase of a business scenario can be determined to be complete based on data in the replication tables 114. Moreover, the preprocessing and scheduled correlation unit 113 can bring the data of the replication tables 114 into a format that can be consumed by the higher layers of the business scenario monitoring application 101. In this manner a correlated data item is generated which can be stored in information model tables 112 of the business scenario monitoring applications 101.

In other words, the data in the replication tables 114 can be seen as raw events of a business scenario instance (e.g., the selection of an appropriate apartment in the example above is an event in a particular relocation process). The assignment of a particular raw event to an instance of a business scenario and their interpretation with respect to their relevance for a status of the business scenario instance can be seen as generation of a correlated event relevant for a status of the particular business scenario instance (e.g., a housing search phase is terminated if a suitable apartment has been found). Thus, the data in the information model tables 112 can processed further and displayed in user interfaces of the business scenario monitoring applications 101 to reflect a status of a particular instance of a business scenario, as will be discussed subsequently.

In order to do so, another functional unit of the business scenario monitoring application 101 will be discussed in a first step. The business scenario monitoring application 101 includes a graphical user interface 103 which allows user to monitor a status of a business scenario. The business scenario monitoring application user interfaces 103 can provide a platform for a user to monitor one or more business scenario interfaces. This can include consuming the correlated events relevant for the particular instances of the business scenarios stored in the information model tables 112. In one example, a business scenario monitoring application user interface 103 can be used to send requests to process database data of the business scenario monitoring application 101. These requests can be formatted according to an industry standard, quasi-standard, and/or in a custom format. In one example, the business scenario monitoring application user interface 103 employs an open data (OData) standardized protocol for requesting database data from the information model tables 112.

Continuing with the example, in some implementations, the OData protocol supports “CREATE”, “READ”, “UPDATE” and “DELETE” database operations. It is built on top of the Hypertext Transfer Protocol (HTTP). Thus, OData services can be consumed by a wide variety of platforms supporting HTTP. Database services are requested in the framework of the OData protocol by a uniform resource identifier. In general, the OData protocol defines a predetermined syntax for the uniform resource identifier. Likewise, the OData protocol defines how the returned data is to be formatted. In addition, the OData protocol specifies that one or more metadata objects corresponding to the returned data objects must be structured in a particular manner. The metadata objects include, e.g., a relationship between different returned data objects.

The example business scenario monitoring application 101 of FIG. 1 includes several additional optional features to facilitate consumption of the correlated events in the information model tables 112 by the business scenario monitoring application user interface 103. As can be seen in FIG. 1, one or more visibility pattern database views 111 can be specified. By calling the one of the one or more visibility pattern database views 111, additional database operations can be carried out on the data in the information model tables 112. For instance, the visibility pattern database views 111 can define select operation, sort operations, aggregate operations, and/or other analytical operations to be carried out on the data in the information model tables 112. Moreover, business scenario metadata can be provided from a business scenario metadata repository 119. This business scenario metadata can also be processed using the visibility pattern database views 111. In this manner, the business scenario monitoring application user interface 103 can be set up to allow a user of a business scenario monitoring application 101 to efficiently monitor a status of one or more business scenario instances.

In the example described above, the raw events in the replication tables 114 are correlated to obtain correlated events that can be consumed by the business scenario monitoring application user interface 103 whenever a scheduled job 115 is executed. As also described above, the points in time when the scheduled jobs 115 are executed are configured through a parameter at runtime of the business scenario monitoring application 101. For instance, the scheduled jobs 115 can be executed periodically (e.g., with a period of one hour, daily, or other period) or according to a non-periodic but fixed schedule.

The timing of the preprocessing and correlation operation when using scheduled jobs is illustrated in FIG. 3a. In the left hand column 301, points in time at which events “occur” are indicated. This can include an update of the replication tables 114 of the business scenario monitoring application 101 in response to a user interaction with an external computer system 106 or a modification of the data of the business scenario monitoring application 101 by a user using graphical user interface 103. Thus, the events in the left hand column 301 can be identified with the raw events described above. As also discussed above, the raw events cannot be consumed for presentation to a user by the business scenario monitoring applications 101. To achieve this, the raw events have to be correlated. In the example of FIG. 3a, this happens periodically upon execution of a scheduled job. As a result, a first group of (three) raw events 317 is processed and correlated upon execution of a first scheduled job 305. This process yields a set of correlated events 309 which can be consumed by a user interface of a business scenario monitoring application 101. This is illustrated in FIG. 3a by a shift of the events in the “visibility” column 302 on the right hand side. Accordingly, a second group of (two) raw events 316 which occur after the execution of the first scheduled job are only correlated upon execution of a second scheduled job 306. After execution of this second scheduled job, the second group of (two) raw events 316 is correlated to obtain a second set of correlated events 309 for further consumption.

The above described technique, including scheduled jobs for generating the correlated events, introduces a predetermined delay between an occurrence of an event and the moment in time when the correlated event is available for consumption in the business scenario monitoring application 101 (e.g., a housing phase is marked as complete in a user interface of the business scenario monitoring application 101). This behavior can prevent a seamless user experience when using the business scenario monitoring application 101. For instance, a user can be left in doubt if a modification in the underlying data has been processed in a correct manner or if there are actual issues in the underlying process.

These issues can be (at least partially) addressed by the techniques described herein. One example implementation will be discussed subsequently in connection with FIG. 1. As it can be seen on the right hand side of FIG. 1, the business scenario monitoring application 101 includes an event-based correlation engine 102. The event-based correlation engine 102 provides for a generation of correlated events triggered by the modification of one or more data items of a data model. Thus, a determination whether a received modification is relevant for a status of the business scenario and a generation of a respective correlated event is triggered by the modification itself and not by a scheduled job as described above.

The event-based correlation engine 102 can include different components to achieve this goal. Firstly, a data model (not shown in FIG. 1) can be defined for a particular type of business scenario. Upon instantiation of this type of business scenario, a data model for this particular instance is instantiated and stored in an event-based correlation data repository 121 of the event-based correlation engine 102. In one example, the data of the data model is stored in one or more data model database tables 123 stored in the data repository 121. Moreover, the data repository 121 of the event-based correlation engine 102 can also include metadata 122 for the data model data. In addition, the event-based correlation engine 102 can include one or more database views 120 to process the data in the data repository 121 for consumption by the business scenario monitoring user interfaces 103. These database views 120 can again be called by a data model OData database service 124 from the business scenario monitoring user interfaces 103, in the same manner as described above in connection with the visibility pattern views 111.

However, upon a modification of the data in the data model of a particular instance of a business scenario, the event-based correlation engine 102 calls a corresponding trigger 116. In one example, a trigger can check if the modification of the data in the data model is relevant for a status of the business scenario. In some examples, a trigger can determine if one or more conditions are met (e.g., if an attribute of the data model has a predetermined value). The execution of the corresponding trigger 116 effects a generation of one or more correlated events in the information model database tables 112. Thus, the result of this process is equal to the result of the scheduled correlation described above. Upon completion of the correlation process, a correlated event data item is available for consumption by the business scenario monitoring application user interfaces 103. For instance, a user of the business scenario monitoring application can receive feedback regarding the status of a particular instance of a business monitoring application. In one example, the user can receive an indication that a particular phase of the instance of the business scenario has been completed. However, in contrast to the scheduled correlation operation above, the event-based correlation engine 102 can provide the correlated event for further consumption shortly after the events occurred (and ideally without any annoying or even noticeable delay).

This process is further illustrated in FIG. 3b. Again, the left hand column 303 indicates points in time when different events occur (e.g., a user of a business scenario monitoring application 101 modifies a data item of the data model of a particular instance of a business scenario). The right hand column 304 indicates points in time when correlated events are available for consumption by a user interface of a business scenario monitoring application 101. As can be seen, in contrast to the sequence of events illustrated in FIG. 3a, the first and second groups of (raw) events 319, 318 are processed into correlated events 311-315 triggered by the occurrence of the raw events 319, 318 by two groups of event-triggered correlation operation. Thus, one raw event is correlated at a time. Therefore, a delay between the occurrence of an event and the availability of the respective correlated event can be shortened.

The above described event-triggered correlation operation will be discussed in more detail in connection with FIG. 2 subsequently. FIG. 2 illustrates a data flow diagram of an example business scenario monitoring application according to an implementation. As described above, the business scenario monitoring application user interface 103 allows for performing database operations on data models associated with instances of business scenarios using a data model OData database service 124. In some examples, the data of the data models is stored in one or more data model tables 123. A modification of the data of the data model can launch a trigger-based correlation operation 116. In this manner, as discussed above, correlated events are generated in one or more information model database tables 112. In addition, the trigger-based correlation operation 116 can also update one or more context database tables 204 one or more database tables including log data (log table) 206. The one or more context database tables 204 can include attributes of a particular instance of a business scenario. The log data can include a log regarding the changes of the data in the one or more information model database tables 112. The log data (in the log tables 206) can be used to restore previous events in the one or more information model database tables 112. The data in the context database tables 204 and the one or more information model database tables 112 can be consumed by the business scenario monitoring application user interface 103 using visibility OData services 110. In this manner, a user of a business scenario monitoring application can receive feedback regarding a status of a particular instance of a business scenario (e.g., if a particular phase of the business scenario has been completed or not).

On the right hand side of FIG. 2, entities for a scheduled correlation of raw events (as discussed in connection with FIG. 1) are depicted. In this mode, a scheduled job 115 is launched according to a predetermined schedule. Upon execution of the scheduled job 115, raw events stored in one or more replication tables 114 are processed in scheduled correlation operation 113. As a result of this operation, correlated events are generated and stored in the one or more information model database tables 112 for further consumption by the business scenario monitoring application user interface 103.

In the following sections, different aspects of the data model and the event-triggered correlation process will be discussed in more detail. In one example, a data model includes structured data items for a business scenario. A run-time instance of the data model is associated with a particular instance of a business scenario. In some examples, data of a data model is disjunct from data coming from external computer systems (e.g., external computer systems 106 in FIG. 1). In one example, a data model table includes a primary key and a scenario instance identifier identifying the corresponding scenario instance. As described above, a user can execute different database operations on the data in the data model tables. For instance, these database operations can include CREATE” (i.e., an operation to create a database data item in the data model), “READ” (i.e., an operation to read a data item in the data model), “UPDATE” (i.e., an operation to change a data item in the data model) or “DELETE” (i.e., an operation to delete a data item in the data model) operations. As the data model is associated with a particular instance of a business scenario, the user can only edit data items associated with this particular business scenario instance.

Upon receiving such modifications, an appropriate trigger is selected and executed to determine a relevance of a user modification of the data model data for the status of an instance of a business scenario. For example, a trigger can evaluate one or more conditions having the modified one or more data items as input. In one example, if the one or more conditions are true, a particular modification is relevant for the status of a particular instance of the business scenario. This means that a correlated event for consumption by the business scenario monitoring application user interface is to be generated. During the correlation operation, the scenario instance identifier of a particular data model can be used to assign the event to a particular instance of the business scenario. The so correlated event can be stored in the information model database tables (e.g., the information model database tables 112 of FIG. 2) for consumption by a user interface of the business scenario monitoring application. Again, this process is triggered by a modification of the user of the business scenario monitoring application, and not by a scheduled job at an arbitrary predetermined time. In this manner, the user can get direct (or at least fast) feedback regarding the status of an instance of a business scenario.

The data model for a type of business scenario can be specified at design time for the business scenario monitoring application. For instance, if a business scenario has multiple phases, the data model can include data items that indicate that a particular phase has been terminated or started. Then, a user can modify these data items in run-time to indicate that a particular phase of a particular instance of a business scenario has been completed (e.g., by checking a corresponding check box). This modification directly triggers a generation of a correlated event, as described above (e.g., a trigger can check the status of the check box). Finally, a status of the instance of the business scenario can be updated in the use interface of the business scenario monitoring application.

The above described techniques will be illustrated by means of an example relocation business scenario subsequently. The already introduced relocation scenario can include four consecutive phases: A work permit request phase, a housing search phase, a transportation organization phase and a moving phase. Each of these phases might require multiple actions by different internal and external business units, which should be monitored in a business scenario monitoring application. In an initialization phase, a user of the business scenario monitoring application can instantiate a relocation business scenario at the business scenario monitoring application for an “employee A”. At this point, the business scenario monitoring application generates a data model associated with the particular instance of the “employee A” relocation business scenario.

At some later point in time, a relocation of “employee A” is in progress. A user of the business scenario monitoring application decides to monitor the status of this particular relocation business scenario. To do so, the user can select the respective instance and review a graphical representation indicating the progress of the relocation business scenario. The user of the business scenario monitoring application finds that the relocation process of employee A is currently in the housing search phase. Thus, a work permit request phase of this particular relocation business scenario instance has already been completed. The user might also find on the user interface an indication that the housing search phase's completion is already overdue. Then, the user might request, using the graphical user interface of the business scenario monitoring application, further details of the particular instance of the relocation business scenario. The user might find out that a suitable apartment for employee A actually has been found. In order to update a status of the relocation business scenario for employee A, the user can check a check box titled “accommodation found” in the graphical user interface of the business scenario monitoring application. This modification by the user can trigger the above described actions: For instance, it can be defined in the data model of the relocation business scenario type that a checking of the check box titled “accommodation found” means that a housing search phase of the relocation business scenario has been completed. Hence, the example business scenario monitoring application includes a trigger that can check the status of the check box titled “accommodation found” upon a modification of the data items of the data model associated with the relocation business scenario instance related to employee A. In the present case, an output condition of the trigger becomes true as the user has checked the check box titled “accommodation found.” Therefore, the business scenario monitoring application can generate a respective correlated event for consumption by the user interface of the business scenario monitoring application. In this process, the scenario instance identifier of the data model can be used to correlate the event (“checkbox ‘accommodation found’ checked”) with the particular business scenario instance. As a consequence, a status indicator of the housing search phase presented to the user on the graphical user interface of the business scenario monitoring application can switch to complete and the relocation business scenario can move to a subsequent phase. In this manner, the user can receive direct feedback to his modifications in the business scenario monitoring application.

In one example, the data tables of the business scenario monitoring applications described above (e.g., the data tables of the data models of the business scenario instances, the information model database tables and/or the replication database tables) can be stored in an in-memory database. This can further accelerate an access to the business scenario monitoring application due to performance increases generally offered by in-memory-type databases. However, the business scenario monitoring application is not limited to be used in connection with an in-memory database.

An example method for generating correlated events in a business scenario monitoring application will subsequently be discussed in connection with FIG. 4. In one operation 401, the business scenario monitoring application obtains a data model including structured data items for a business scenario, where executing an instance of the business scenario involves contributions of two or more computer systems. In further operations 402, 403, the business scenario monitoring application generates an instance of the business scenario and obtains a modification of one or more data items of the data model relevant for a status of the business scenario. Then, in subsequent operations triggered by the modification of one or more data items of the data model, the business scenario monitoring application determines that the received modification is relevant for a status of the business scenario and generates an event data item (“correlated event”) being indicative of a status of the business scenario. Eventually, in further operations 406 and 407 the business scenario monitoring application stores the event data item in a database object (e.g., the information model database tables) to be provided to a user using a user interface of a business scenario monitoring application and provides the event data item to a user using a user interface of a business scenario monitoring application.

In the previous sections, the components of the business scenario monitoring application have been described as functional units. These functional units can be embodied in different hardware and software environments, as will be discussed in the subsequent sections.

At a high level, the business scenario monitoring application is associated with a computer or processor. A computer or processor comprises an electronic computing unit (e.g., a processor) operable to receive, transmit, process, store, or manage data and information associated with an operating environment of the database system. As used in the present disclosure, the term “computer” or “processor” is intended to encompass any suitable processing device. The term “processor” is to be understood as being a single processor that is configured to perform operations as defined by one or more aspects described in this disclosure, or the “processor” comprises two or more processors, that are configured to perform the same operations (e.g., in a manner that the operations are distributed among the two or more processors). The processor may comprise multiple organic field-effect transistors or thin film transistors or a combination thereof. This may allow processing the operations in parallel by the two or more processors. The two or more processors may be arranged within a supercomputer, the supercomputer may comprise multiple cores allowing for parallel processing of the operations. For instance, a computer or processor may be a desktop or a laptop computer, a cellular phone, a smartphone, a personal digital assistant, a tablet computer, an e-book reader or a mobile player of media. Furthermore, the operating environment of the database system can be implemented using any number of servers, as well as computers other than servers, including a server pool. Indeed, the computer or processor and the server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the computer, processor and server may be adapted to execute any operating system, including Linux, UNIX, Windows, Mac OS, iOS, Android or any other suitable operating system.

The term “computing device,” “server,” or “processor” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array), a CUDA (Compute Unified Device Architecture) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and operating environment can realize various different computing model infrastructures. In enterprise systems, there are OLTP (OnLine Transaction processing) systems used to carry out business processes of a company where employees and other stakeholders, such as suppliers or customers, follow a business process which may result in business documents created in a database of the OLTP system. The database system can include in-memory databases in addition to the persistent databases described in connection with FIGS. 1 and 2 and thereby exploit recent innovations in hardware to run a database in main memory. In an implementation of the present disclosure described herein, the servers may be types of a Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC), a ByDesign platform, SuccessFactors Platform, ERP Suite technology or in-memory database such as High Performance Analytic Appliance (HANA) platform. In an aspect, the servers may be based on two different of the above mentioned platforms.

Regardless of the particular implementation, “software” or “operations” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Python and R, Perl, any suitable version of 4GL, as well as others.

The figures and accompanying description illustrate example processes and computer-implementable techniques. However, the database system operating environment (or its software or hardware components) contemplates using, implementing, or executing any suitable technique for performing these and other processes. It will be understood that these processes are for illustration purposes only and that the described or similar techniques may be performed at any appropriate time, including concurrently, individually, or in combination. In addition, many of the operations in these processes may take place simultaneously, concurrently, and/or in different orders or combinations than shown. Moreover, operating environment may use processes with additional operations, fewer operations, and/or different operations, so long as the methods remain appropriate.

Aspects of the subject-matter and the operations described in this specification can be implemented in digital electronic circuitry, semiconductor circuits, analog circuits, or in computer software, firmware, or hardware, including the structures disclosed in this specification and their structural equivalents, or in combinations of one or more of them. Embodiments of the subject-matter described in this specification can be implemented as one or more computer programs, i.e., one or more modules of computer program instructions, encoded on computer storage medium for execution by, or to control the operation of a data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

A computer program (also known as a program, software, software application, script, or code) or “user interface” can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) “icons,” some or all associated with a web browser, such as interactive fields, pull-down lists, and buttons operable by the user of the computing device hosting the UI. These and other UI icons may be related to or represent the functions of the web browser. The term “browser user interface” refers to a graphical user interface embedded in a web browser environment on the remote computing device. The browser user interface may be configured to initiate a request for a uniform resource locator (URL) and may be configured to display a retrieved web page such as an HTML coded web page. The browser user interface may comprise displayed or hidden icons which, upon activation, initiate an associated electronic process inside or outside the remote computing device. For example, the browser user interface may be Internet Explorer, Chrome or Firefox. “Creating an icon” is to be understood as generating a new icon on the user interface. “Modifying an icon” is to be understood as changing a property of an existing icon on the user interface. “Deleting an icon” is to be understood as vanishing an existing icon on the user interface, e.g., for replacement by a newly created icon. “Updating the user interface” thereby is to be understood as creating, modifying, or deleting an icon on the user interface.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer or computer or processor may be a processor for performing actions in accordance with instructions and one or more memory devices for storing instructions and data. Generally, a computer or computer or processor will also include, or be operatively coupled to receive data from or transfer data to, or both, one or more mass storage devices for storing data, e.g., magnetic, magneto optical disks, or optical disks. However, a computer or computing device need not have such devices. Moreover, a computer or computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the user interface described in this specification can be implemented on a computer having a non-flexible or flexible screen, e.g., a CRT (cathode ray tube), LCD (liquid crystal display) or OLED (organic light emitting diode) monitor, for displaying information to the user and a keyboard and a pointer, e.g., a finger, a stylus, a mouse or a trackball, by which the user can provide input to the computer. Other kinds of devices can be used to provide for interaction with a user as well; for example, feedback provided to the user can be any form of sensory feedback, e.g., touch feedback, visual feedback, auditory feedback, or tactile feedback; and input from the user can be received in any form, including acoustic, speech, touch or tactile input. In addition, a computer or computer or processor can interact with a user by sending documents to and receiving documents from a device that is used by the user; for example, by sending web pages to a web browser on a user's user device in response to requests received from the web browser.

Implementations of the subject-matter described in this specification can be implemented in a computing system that includes a back end component, e.g., as a server, or that includes a middleware component, e.g., an application server, or that includes a front end component, e.g., a user computer having a graphical user interface or a Web browser through which a user can interact with an implementation of the subject-matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any implementation or on the scope of what may be claimed, but rather as descriptions of features that may be specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the operations recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer implemented method, comprising:
obtaining, by operation of a hardware processor, a data model including structured data items for a business scenario, wherein executing an instance of the business scenario involves contributions of two or more computer systems;
generating an instance of the business scenario;
obtaining a modification of one or more data items of the data model relevant for a status of the business scenario;
triggered by the modification of one or more data items of the data model, determining that the received modification is relevant for a status of the business scenario;
triggered by the modification of the one or more data items of the data model, generating an event data item being indicative of a status of the business scenario; and
storing the event data item in a database object to be provided to a user via a user interface of a business scenario monitoring application.

2. The computer-implemented method of claim 1, wherein the data model and the database object including the event data item are stored in an in-memory database.

3. The computer-implemented method of claim 1, wherein the relevance for a status of the business scenario is determined by evaluating a condition having the modified one or more data items as input.

4. The computer implemented method of claim 1, further comprising:
obtaining a further modification of one or more second data items of the data model relevant for a status of the business scenario;
triggered by the further modification of one or more second data items of the data model, determining that the received further modification is relevant for a status of the business scenario;
triggered by the further modification of the one or more second data items of the data model, generating a second event data item being indicative of a status of the business scenario; and
storing the second event data item in a database object to be provided to a user via a user interface of a business scenario monitoring application.

5. The method of claim 1, wherein the obtained modification originates from the user interface of the business scenario monitoring application.

6. The method of claim 1, wherein the modification of one or more data items is a create operation, an update operation, or a delete operation, or a combination of two or more of these operations.

7. The method of claim 1, wherein the one or more data items of the data model are stored in one or more data tables referenced by the data model.

8. The method of claim 7, wherein the one or more data tables each include a primary key and a business scenario instance identifier identifying the corresponding business scenario instance.

9. The method of claim 8, wherein the event data item being indicative of a status of the business scenario is correlated to the scenario instance by using the scenario instance identifier.

10. The method of claim 9, wherein storing the event data item in a database object includes storing information indicative of the corresponding scenario instance.

11. The method of claim 7, wherein code encoding the processes for determining that the received modification is relevant for a status of the business scenario is stored in an in-memory database object.

12. The method of claim 1, wherein receiving a modification of one or more data items of the data model includes receiving an OData service request.

13. The method of claim 1, further comprising:
receiving a read request from the user interface of the business scenario monitoring application;
providing status data based on the event data item to the user interface of the business scenario monitoring application for display to a user.

14. The method of claim 13, wherein the write request is triggered by the modification of one or more data items of the data model.

15. The method of claim 1, wherein the business scenario includes one or more predetermined phases, and a status of the business scenario includes that a predetermined phase has been started or that a predetermined phase has been completed.

16. The method of claim 15, wherein each phase of the one or more phases involves a contribution of one of the two or more computer systems.

17. The method of claim 1, further comprising:
receiving data from at least one of the two or more computer systems;
storing the received data in a database object.

18. The method of claim 17, wherein determining that the received modification is relevant for a status of the business scenario includes evaluating data received from the least one of the two or more computer systems.

19. A computer readable medium storing instructions thereon which when executed by a processor cause the processor to:
obtain a data model including structured data items for a business scenario, wherein executing an instance of the business scenario involves contributions of two or more computer systems;
generate an instance of the business scenario;
obtain a modification of one or more data items of the data model relevant for a status of the business scenario;
triggered by the modification of one or more data items of the data model, determine that the received modification is relevant for a status of the business scenario;
triggered by the modification of the one or more data items of the data model, generate an event data item being indicative of a status of the business scenario; and
store the event data item in a database object to be provided to a user via a user interface of a business scenario monitoring application.

20. A system comprising:
one or more processors; and
a computer-readable medium storing instructions executable by the one or more processors to perform operations comprising:
obtaining a data model including structured data items for a business scenario, wherein executing an instance of the business scenario involves contributions of two or more computer systems;
generating an instance of the business scenario;
obtaining a modification of one or more data items of the data model relevant for a status of the business scenario;
triggered by the modification of one or more data items of the data model, determining that the received modification is relevant for a status of the business scenario;
triggered by the modification of the one or more data items of the data model, generating an event data item being indicative of a status of the business scenario; and
storing the event data item in a database object to be provided to a user via a user interface of a business scenario monitoring application.
